(19) United States
(12) Patent Application Publication
(10) Pub. No.: US 2009/0208714 A1
(43) Pub. Date: Aug. 20, 2009

(54) PRE-COATED NON-WOVEN MAT-FACED GYPSUM PANEL

(75) Inventors: Alan E. Currier, Atlanta, GA (US); Gary A. Ricards, Peachtree City, GA (US)

Correspondence Address: PATENT GROUP GA030-43;Georgia-Pacific LLC, 133 PEACHTREE STREET, N.E., ATLANTA, GA, 30303-1847, US

(73) Assignee: GEORGIA-PACIFIC GYPSUM LLC, Atlanta, GA (US)

(21) Appl. No.: 12/372,032

(22) Filed: Feb. 17, 2009

Related U.S. Application Data
(60) Provisional application No. 61/029,409, filed on Feb. 18, 2008.

(51) Int. Cl. B32B 13/02; B32B 7/02; B29C 65/54

(52) U.S. Cl. 428/212; 156/44

(57) ABSTRACT

A gypsum panel suitable for use in constructing a roof deck comprising a set gypsum core having at least about 0.3 pounds of reinforcing fibers per 100 square feet and a density sufficient to provide a board weight of 130 lbs per 100 square feet, where the core sandwiched between and faced with coated non-woven fibrous mats, wherein the free surface of each mat is pre-coated with a combination of a mineral pigment and a polymer latex adhesive binder applied to the mat surfaces as an aqueous coating composition.

### CROSS-REFERENCE TO RELATED APPLICATION

This application claims the benefit of and incorporates by reference co-pending provisional application Ser. No. 61/029,409 filed Feb. 18, 2008.

### BACKGROUND OF THE INVENTION

1. Field of the Invention

This invention relates to an improved non-woven, fibrous mat-faced gypsum board or panel, prepared with pre-coated fibrous mats. The board is suitable for constructing roof decks using the Built-up Roofing (BUR) method, single layer, e.g., fully adhered, membranes, or any other roof construction technique.

2. Description of Related Art

In the prior art BUR construction, the fibrous mat-faced gypsum boards are laid out on the roof, possibly positioned over foam boards for added insulation. The outer (upper) surface of the gypsum board is then covered. In one of the most common approaches previously used for finishing the roof, multiple layers of reinforcing plies and asphalt (hot-mopped and torched asphaltic systems) overlay the gypsum board before a final surface layer, such as a mineral aggregate, is applied. Bitumen-saturated felt, coated felt, polyester felt also have been used as the reinforcing plies.

In a more recent development, the BUR approach to roof construction is being replaced by single-ply, e.g., fully adhered, roofing membranes, particularly “peel and stick” products (see for example WO 2006/065325). In this construction, a single layer of a waterproof polymeric material, supplied in roll form, such as ethylene propylene diene rubber (EPDM), polyvinyl chloride (PVC), chlorosulfonated polyethylene (CSPE) and thermoplastic polyolefin (TPO), is rolled onto the roof so that the edge of one membrane overlaps the edge of an adjacent membrane.

In order to improve the outer surface of the fibrous mat-faced gypsum board for more uniform application of an initial asphalt layer or to enhance the bond strength of the single-ply membrane system to the fibrous mat-faced gypsum board without the need for field priming, the upper fibrous surface of the fibrous mat-faced gypsum board has been post-coated, i.e., coated after the fibrous mat facers had been applied to the gypsum core with an aqueous-based coating.

Two post-coated boards are currently available from Georgia-Pacific Gypsum, DensDeck Prime® roof board and DensDeck DuraGuard® roof board.

In making the DensDeck Prime® gypsum board roofing product, a gypsum slurry, which sets to form the gypsum core, is laid down on the top of one fibrous mat (basis weight of about 2 pounds per 100 square feet), fed from a roll and advanced by a conveyor, while an opposing fibrous mat (basis weight of about 2 pounds per 100 square feet) is laid onto the upper surface of the gypsum slurry. In order to form the edges of the board, the opposite edges of the lower mat are folded upwardly and then turned inwardly around the setting core of gypsum as the opposing mat is laid onto the upper surface. A coating is later applied to the upper surface mat.

When made in this manner, the top surface that is coated is the surface that has the exposed ends of the fibrous mat used to form the board edges. Unfortunately, these edges have shown a tendency to be damaged by inadvertent impacts during installation. In addition, while the application of this coating improved the performance of the board, especially in the context of the single-ply membrane system, there still was a need for additional priming in some cases.

In making the DensDeck DuraGuard® gypsum board roofing product, a gypsum slurry, which sets to form the gypsum core, is laid down on the top of one pre-coated, low basis weight fibrous mat (uncoated basis weight of about 1.5 pounds per 100 square feet), fed from a roll and advanced by a conveyor, while an opposing uncoated fibrous mat (basis weight of about 2 pounds per 100 square feet) is laid onto the upper surface of the gypsum slurry. The precoated mat serves as the top surface of the board during installation and use and is post-coated with an aqueous latex coating (paint).

While these prior art gypsum roofing products have many advantageous features, requiring a separate coating step during their manufacture makes such boards cumbersome to produce in conventional gypsum board plants. One way to avoid such an approach is to use pre-coated mats for making the boards, as for example described in U.S. Published Application 2004/0209074. Unfortunately, attempts to make a ¼ inch thick gypsum roofing board by simply replacing the prior art facers with such pre-coated mats did not yield a product able either to pass the Class A fire tests for roof coverings (ASTM E-108), especially one or more of the Intermittent flame exposure test, the Spread of flame test, and the Burning Brand test and/or to obtain an uplift resistance Class 1 roof approval rating (FM 4470 and/or ANSI/UL 1897) in excess of 90 lbs/square foot (4.31 kPa); properties necessary to provide a widely accepted commercial product.

The present invention is directed to a new design of a gypsum board that can be used as a roofing board product. The gypsum board of the present invention usually has a nominal thickness of at least ¼ inch and is designed such that it can be used to replace the currently used gypsum roofing boards. The new design provides improvements in both the method of manufacture and in the characteristics of the product for roofing and other applications.

### SUMMARY OF THE INVENTION

In one embodiment, the present invention relates to gypsum panel comprising:
(1) a first coated, non-woven fibrous mat, the non-woven fibrous mat containing glass fibers nominally about 10 to 17 microns in diameter, the coating on the first coated non-woven fibrous mat having a basis weight of 3 to 6 pounds of solids per 100 square feet of mat and comprising a dried aqueous mixture of (i) a mineral pigment and (ii) a polymer latex adhesive binder and being substantially free of talc, the polymer latex adhesive binder comprising on a dry weight basis at least about 1% and no more than about 17% by weight of the coating, the first coated non-woven fibrous mat having a coated side and a non-coated side;
(2) a set gypsum core, the core having a density of at least 130 pounds per 100 square feet of the panel and comprising at least about 0.3 lbs. of reinforcing fibers per 100 square feet of the panel, and
(3) a second coated non-woven fibrous mat, the non-woven fibrous mat containing glass fibers nominally about 10 to 17 microns in diameter, the coating on the second coated non-woven fibrous mat having a basis weight of 3 to 6 pounds of solids per 100 square feet of mat and comprising a dried aqueous mixture of (i) a mineral pigment, and (ii) a polymer latex adhesive binder, the polymer latex adhesive binder comprising on a dry weight basis at least about 1% and no more than about 17% by weight of the coating, the second coated non-woven fibrous mat having a coated side and a non-coated side;
wherein the first and second coated non-woven fibrous mats are adhered to the set gypsum core by set gypsum penetrating only partway into the non-coated sides of the fibrous mats; and
wherein the gypsum panel is prepared by depositing a gypsum slurry for forming the set gypsum core onto the non-coated side of the first coated non-woven fibrous mat and forcing the non-coated side of the second coated non-woven fibrous mat into contact with a free surface of the gypsum slurry and allowing the gypsum slurry to harden to form the gypsum core, the first and second coated non-woven mats having a porosity which allows water to evaporate through the coated mats from the gypsum core during preparation of the panel.

In another embodiment, the invention relates to gypsum panel wherein at least one of the non-woven fibrous mat facing sheets that sandwich the gypsum core (and in particular the one destined to serve as the top of the board when the board is installed on a roof) and which contains glass fibers nominally about 10 to 17 microns in diameter, specifically contains glass fibers having a diameter of no greater than about 11.5 microns (i.e., is made using H fibers) and most, if not all of the fibers used to make the mat also have a length somewhere between about one-quarter (¼) to about three-quarter (¾) inch. In this embodiment, it is preferred that at least about 75 wt % of the fibers used to prepare the mat have a length between about one-quarter (¼) to about three-quarter (¾) inch and more preferably between about one-quarter (¼) to about one-half (½) inch and even more preferably at least about 90 wt % of the fibers used to prepare the mat have a length between about one-quarter (¼) to about three-quarter (¾) inch, or between about one-quarter (¼) to about one-half (½) inch. For example, as discussed hereafter, it has been observed that board whose top surface is a pre-coated mat prepared using 75% by weight ¼ inch H fibers (about 10-11.5 microns in diameter) and 25% by weight ¾ inch H fibers has shown unexpected benefits in BUR applications when using liquid adhesives.

In an alternate embodiment the present invention also relates to a method of making a gypsum panel comprising
(1) depositing an aqueous slurry of calcined gypsum containing reinforcement fibers onto a first coated non-woven fibrous mat, the non-woven fibrous mat containing glass fibers nominally about 10 to 17 microns in diameter, the coating on the first coated non-woven fibrous mat having a basis weight of 3 to 6 pounds of solids per 100 square feet of mat and comprising a dried aqueous mixture of (i) a mineral pigment and (ii) a polymer latex adhesive binder and being substantially free of talc, the polymer latex adhesive binder comprising on a dry weight basis at least about 1% and no more than about 17% by weight of the coating, the first coated non-woven fibrous mat having a coated side and a non-coated side and wherein the slurry is deposited on the non-coated side;
(2) applying a second coated non-woven fibrous mat onto a free surface of the gypsum slurry, the non-woven fibrous mat containing glass fibers nominally about 10 to 17 microns in diameter, the coating on the second coated non-woven fibrous mat having a basis weight of 3 to 6 pounds of solids per 100 square feet of mat and comprising a dried aqueous mixture of (i) a mineral pigment, and (ii) a polymer latex adhesive binder, the polymer latex adhesive binder comprising on a dry weight basis at least about 1% and no more than about 17% by weight of the coating, the second coated non-woven fibrous mat having a coated side and a non-coated side and wherein the second coated non-woven mat contacts the gypsum slurry on the non-coated side;
(3) forcing the first and second coated non-woven fibrous mats and the gypsum slurry there between to a constant thickness and
(4) hardening and drying the gypsum slurry with heating to form a set gypsum core having a density of at least 130 pounds per 100 square feet of the panel and comprising at least about 0.3 lbs. of reinforcing fibers per 100 square feet of the panel
wherein the first and second coated non-woven fibrous mats are adhered to the set gypsum core by set gypsum penetrating only partway into the non-coated sides of the fibrous mats.

In a related embodiment, at least one of the non-woven fibrous mat facing sheets that sandwich the gypsum core (and in particular the one destined to serve as the top of the board when the board is installed on a roof) and which contains glass fibers nominally about 10 to 17 microns in diameter, specifically contains glass fibers having a diameter of no greater than about 11.5 microns (i.e., is made using H fibers) and most, if not all of the fibers used to make the mat also have a length somewhere between about one-quarter (¼) to about three-quarter (¾) inch. In this embodiment, it is preferred that at least about 75 wt % of the fibers used to prepare the mat have a length between about one-quarter (¼) to about three-quarter (¾) inch and more preferably between about one-quarter (¼) to about one-half (½) inch and even more preferably at least about 90 wt % of the fibers used to prepare the mat have a length between about one-quarter (¼) to about three-quarter (¾) inch, or between about one-quarter (¼) to about one-half (½) inch. For example, as discussed hereafter, it has been observed that a board whose top surface is a pre-coated mat prepared using 75% by weight ¼ inch H fibers (about 10-11.5 microns in diameter) and 25% by weight ¾ inch H fibers has shown unexpected benefits in BUR applications when using liquid adhesives.

In yet another embodiment, the present invention relates to a roof deck assembly comprising: (a) a supporting structure, (b) a gypsum panel as described above overlying the supporting structure and (c) a finishing material overlying the gypsum panel.

In still another embodiment, the present invention also relates to a parapet roof assembly or parapet wall assembly comprising (a) a supporting structure, (b) a gypsum panel described above overlying the supporting structure and (c) a finishing material overlying the gypsum panel.

### BRIEF DESCRIPTION OF THE DRAWINGS

The objects, features, and advantages of the invention will be apparent from the following more detailed description of certain embodiments of the invention and as illustrated in the accompanying drawings. The drawings are highly schematic and are not necessarily to scale, emphasis instead being placed upon illustrating the features of the invention.

FIG. 1, shows a highly schematic view of an apparatus for making the gypsum board or panel of the present invention and the board being assembled thereon. As noted one potential use for the described board is as a roofing board.

FIG. 2 is an isometric view of a gypsum structural panel of the present invention.

FIG. 3 is a perspective view partly broken away and in section of an exemplary roof deck system incorporating a gypsum structural panel in accordance with the present invention.

FIG. 4 is an enlarged sectional view taken along line 4-4 of FIG. 3.

### DETAILED DESCRIPTION OF THE INVENTION

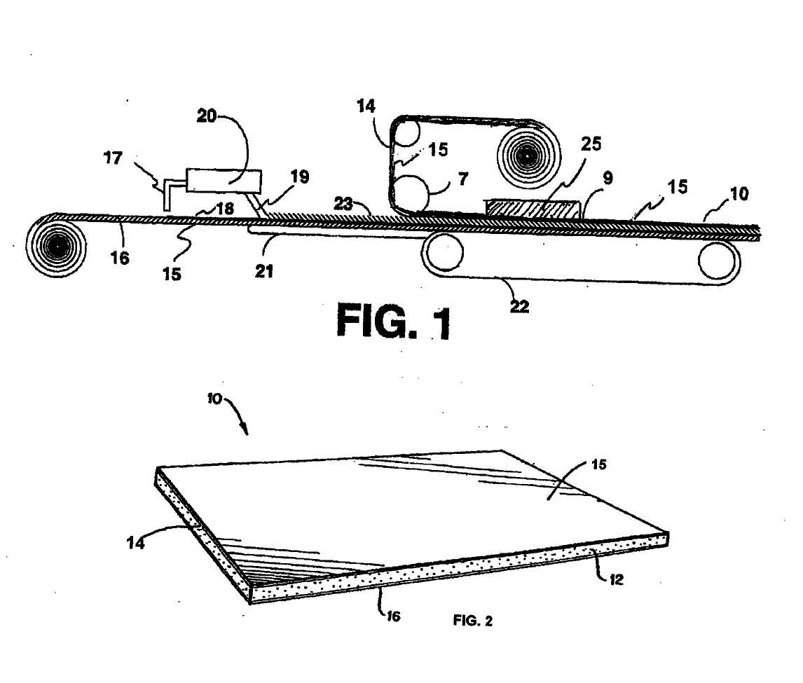

As shown in FIGS. 1 and 2, a gypsum roofing board or panel of the present invention 10 can be manufactured by enmeshing or entangling a set gypsum board core 24 with two pre-coated non-woven fibrous mats, 14 and 16, preferably both are predominately glass fiber (fiberglass) mats. Gypsum panels of the present invention can be manufactured at nominal thicknesses between about ¼ inch and one inch. Panels having a thickness of ¼ inch, ½ inch, ⅝ inch, ¾ inch, ⅞ inch and 1 inch are contemplated.

In the illustrated embodiment, the outer surfaces of both of the non-woven mats have been pre-coated with a dried (heat cured) aqueous coating (indicated by numerals 15 in the sole figure) of an aqueous coating composition containing a combination (e.g., a mixture) of a mineral pigment or filler and an organic binder of a polymer latex adhesive. In the broad aspects of the invention, the coatings applied to the mats 14 and 16 do not have to be the same. But, for convenience the coating formulations used for both mats often is the same.

By “pre-coated” is meant that the non-woven fibrous mats have a dried, adherent coating of what was originally an aqueous coating composition, as hereinafter defined in more detail, applied to one of their surfaces before the non-woven mats are used to make the gypsum board of the present invention.

Examples of polymer latex adhesive binders suitable for use in formulating the mat coating in the present invention include, but are not limited to: styrene-butadiene-rubber (SBR), styrene-butadiene-styrene (SBS), ethylene-vinyl-chloride (EVCl), poly-vinylidene-chloride (PVdCl) and poly(vinylidene) copolymers, modified poly-vinyl-chloride (PVC), poly-vinyl-alcohol (PVOH), ethylene-vinyl-acetate (EVA), poly-vinyl-acetate (PVA) and polymers and copolymers containing units of acrylic acid, methacrylic acid, their esters and derivatives thereof (acrylic-type polymers), such as styrene-acrylate copolymers. Most, if not all of these materials are available as latex formulations.

The polymer latex adhesive binder used in formulating the coating preferably comprises certain UV resistant latex adhesives identified hereafter, and must, in combination with the mineral pigment or filler, provide a desired level of porosity at the below-recited usage levels, also as determined by an easily performed test, after the coating has been applied to the fibrous mat.

Particularly preferred polymer latex adhesive binders are certain UV resistant polymer latex adhesives that demonstrate a satisfactory level of hydrophobicity, as determined by an easily performed test that also is described in detail below. When coated using these preferred binders, the gypsum roofing board or panel of the present invention also exhibits exceptional weathering characteristics.

As used throughout the specification and claims, the terms hydrophobic, hydrophobicity and the like are intended to embrace polymers which yield a three minute Cobb value in the precoated non-woven fibrous mat used as the first coated non-woven fibrous mat (becomes the top surface when installed) in the test for determining a Cobb value as detailed below, of below about 1.5 grams, and preferably below about 0.5 gram.

Preferably, the gypsum panel suitable for use in constructing a roof deck also exhibits a two (2) hour Cobb value in the test for determining a Cobb value as detailed below of less than 3 grams, preferably less than 2.5 grams, more preferably less than 2 grams and most preferably less than 1.5 grams.

The pre-coated non-woven fibrous mats used in the preparing the gypsum board of the present invention can be prepared by applying an aqueous coating composition containing the noted solid constituents to the non-woven fibrous mats in an amount on a dry weight basis of between about 3 and 6 lbs., per 100 sq. ft. of mat and preferably in an amount on a dry weight basis of between about 3.5 and 4.5 lbs., per 100 sq. ft. of mat.

The composition of the set gypsum core of the gypsum roofing panel of the present invention is generally similar to that used in other gypsum products, known as gypsum wallboard, dry wall, gypsum board, gypsum lath and gypsum sheathing. The set gypsum core is formed by mixing water with powdered anhydrous calcium sulfate or calcium sulfate hemi-hydrate (CaSO₄.1/2H₂O), also known as calcined gypsum, to form an aqueous gypsum slurry, and thereafter allowing the slurry mixture to hydrate or set into calcium sulfate dihydrate (CaSO₄.2H₂O), a relatively hard material.

The core of the roofing board will usually comprise at least about 80 wt. percent of set gypsum (fully hydrated calcium sulfate) and typically at least about 85 wt. percent. The composition from which the set gypsum core of the board or panel is made can also include a variety of optional additives, including, for example, those included conventionally in gypsum wallboard. Examples of such additives include set accelerators, set retarders, foaming agents, and dispersing agents.

In order to satisfactorily achieve the desired properties of fire resistance and wind uplift resistance in gypsum panels of nominal ¼ inch thickness, applicants have determined that the gypsum core in the roofing board of the present invention must include at least about 0.3 lbs of reinforcing fibers, preferably chopped glass fibers, per 100 square feet of roofing board. Usually, the gypsum core in the roofing board of the present invention will include about 0.4 to 0.6 lbs. of reinforcing fibers per 100 square feet of roofing board to ensure that boards having a nominal ¼ inch thickness meet or exceed the desired properties of fire resistance and wind uplift resistance. The commercial gypsum roofing boards previously available from Georgia-Pacific Gypsum, DensDeck® roof board, DensDeck Prime® roof board and DensDeck DuraGuard® roof board, used a maximum of about 0.2 lbs. of reinforcing fibers per 100 square feet of roofing board.

Fibers having a diameter between 10 and 17 microns and having a length between 6.35 and 12.7 millimeters (¼ to ½ inch) should be suitable as the reinforcing fibers. Usually fibers having a diameter of 16 microns and a 12.7 mm length are used. These fibers are mixed into the gypsum slurry during board manufacture. In particular, applicants have determined that the above-noted, higher level of reinforcing fibers are needed in the core in order for the ¼ inch thick board to pass the Class A fire tests for roof coverings (ASTM E-108), especially each of the Intermittent flame exposure test, the Spread of flame test, and the Burning Brand test and/or to obtain an uplift resistance Class 1 roof approval rating (FM 4470 and/or ANSI/UL 1897) in excess of 90 lbs/square foot (4.31 kPa).

The core of the gypsum board also preferably includes an additive that improves the water-resistant properties of the core, i.e., the ability of the set gypsum composition to resist being degraded by water, for example, to resist dissolution.

Examples of materials which have been reported as being effective for improving the water-resistant properties of gypsum products are: poly(vinyl alcohol), with or without a minor amount of poly(vinyl acetate); metallic resinates; wax or asphalt or mixtures thereof, usually supplied as an emulsion; a mixture of wax and/or asphalt and also cornflower and potassium permanganate; water insoluble thermoplastic organic materials such as petroleum and natural asphalt, coal tar, and thermoplastic synthetic resins such as poly(vinyl acetate), poly(vinyl chloride) and a copolymer of vinyl acetate and vinyl chloride and acrylic resins; a mixture of metal rosin soap, a water soluble alkaline earth metal salt, and residual fuel oil; a mixture of petroleum wax in the form of an emulsion and either residual fuel oil, pine tar or coal tar; a mixture comprising residual fuel oil and rosin; aromatic isocyanates and diisocyanates; organopolysiloxanes, for example, of the type referred to in U.S. Pat. Nos. 3,455,710; 3,623,895; 4,136,687; 4,447,498; and 4,643,771; siliconates, such as available from Dow Corning as Dow Corning 772; a wax emulsion and a wax-asphalt emulsion each with or without such materials as potassium sulfate, alkali and alkaline earth aluminates, and Portland cement; a wax-asphalt emulsion prepared by adding to a blend of molten wax and asphalt an oil-soluble, water-dispersing emulsifying agent, and admixing the aforementioned with a solution of case in which contains, as a dispersing agent, an alkali sulfonate of a polyarylmethylene condensation product. Mixtures of these additives can also be employed.

A mixture of materials, namely, one or more of poly(vinyl alcohol), siliconates, wax emulsion and wax-asphalt emulsion of the aforementioned types, for example, also can be used to improve the water resistance of gypsum products, such as described in aforementioned U.S. Pat. No. 3,935,021.

Applicants also have determined that to satisfactorily achieve the desired properties of fire resistance and wind uplift resistance in a ¼ inch thick board, the core of the gypsum board also must have a density sufficient to yield a ¼ inch thick board of at least 130 pounds per 100 square feet. Preferably, the set gypsum in the core of the gypsum board has a density sufficient to yield a ¼ inch thick board of between about 135 to 145 pounds per 100 square feet. Obviously thicker boards will have a proportionally higher weight per 100 square feet. The manufacture of a core of a predetermined density can be accomplished using known techniques, for example, by controlling or adjusting the amount of foam (soap) added into the aqueous gypsum slurry from which the core is formed and/or by controlling how the board is formed or molded before it cures.

In accordance with the present invention, both surfaces of the set gypsum core are faced with pre-coated fibrous mats. Thus, coated mats are prepared in advance (pre-coated) and are used in making the non-woven fibrous mat faced gypsum roofing board. The coating on the mats must be sufficiently porous to permit water in the aqueous gypsum slurry from which the gypsum core is made to evaporate in its vaporous state there through during manufacture of the board.

The gypsum board of the present invention is made by forming an aqueous gypsum slurry which contains excess water (i.e., water in excess of that needed to hydrate the calcined gypsum from which the slurry is made) and depositing the gypsum slurry on a non-coated side of a horizontally oriented moving web of a pre-coated non-woven fibrous mat, i.e., with the coated mat surface oriented away from the deposited gypsum slurry. Another moving web of a pre-coated non-woven fibrous mat is then placed on the upper free surface of the aqueous gypsum slurry. Again, this additional pre-coated mat is oriented so that the non-coated side of the mat contacts the upper, free surface of the gypsum slurry, i.e., with the coated mat surface oriented away from the deposited gypsum slurry. In this way, the gypsum slurry is sandwiched between the two pre-coated mats. A roller or a forming plate 25 (see FIG. 1) compresses the sandwich assembly to the desired thickness, such as a board of a nominal ¼ inch thickness, for the gypsum board or panel of the present invention. Aided by subsequent heating of the assembly in an oven, excess water evaporates through the pre-coated mats as the calcined gypsum fully hydrates and sets.

The non-woven fibrous mats comprise a fiber material that is capable of forming a strong bond with the set gypsum comprising the core of the gypsum board through a mechanical-like interlocking between the interstices of the fibrous mat and portions of the gypsum core filling those interstices. Examples of fiber materials useful for the non-woven mats include (1) a mineral-type material such as glass fibers, (2) synthetic resin fibers and (3) mixtures or blends thereof. Glass fiber mats are preferred for making the pre-coated mat. Nonwoven mats such as made from chopped strands and continuous strands can be used satisfactorily. The strands of such mats typically are bonded together to form a unitary structure by a suitable adhesive. The fiber mats can range in thickness, for example, from about 0.51 to about 0.66 millimeters (mm) (20-26 mils). The aforementioned fibrous mats are known and are commercially available.

Preferably, a non-woven fiberglass mat comprising chopped, nonwoven, fiberglass filaments oriented in a random pattern and bound together with a resin binder, typically a urea-formaldehyde resin adhesive and/or an acrylate adhesive resin is used. Use of a urea-formaldehyde resin adhesive binder, optionally modified with a thermoplastic extender or cross-linker, such as an acrylic cross-linker, has been shown to be suitable. Usually, the same mat adhesive is used for both of the non-woven fiberglass mats used to sandwich the gypsum core. In the broad practice of this invention, fibers having a diameter between 10 and 17 microns and having a length between 6.35 and 25.4 millimeters (¼ and 1 inch) should be suitable for making the non-woven mats in the broad practice of the present invention. In particular, mats made using fibers having a diameter of 13 microns (K fibers) and a length of 19 mm (¾ inch) have proven to be acceptable in many instances. Fiber glass mats of this type are commercially available, e.g., from Owens-Corning.

In BUR applications in which a liquid adhesive, including for example hot (bitumen) asphalt or coal tar, or a cold adhesive, including cold solvent-based commercial roofing adhesives based on bitumen or other polymer materials, is first applied to the upper surface of the gypsum panel, applicants have discovered that best results are obtained if the pre-coated non-woven fibrous mat containing glass fibers nominally about 10 to 17 microns in diameter, onto which the adhesive is applied, specifically contains glass fibers having a diameter of no greater than about 11.5 microns, (e.g., which consists essentially of H fibers) and if most, if not all of the fibers used to make the mat have a length somewhere between about one-quarter (¼) to about three-quarter (¾) inch. Applicants have observed that, in such BUR applications, using a gypsum panel faced with a pre-coated mat having larger fiber diameters (e.g., K fibers) and/or longer fiber lengths (e.g., one inch) tends to cause excessive frothing (off-gassing) of the adhesive. This frothing interferes with the formation of a suitable bond between the roofing material or membrane and the opposing surface of the gypsum panel. One possible consequence of such frothing is the formation of blisters, a small void or pocket between the roofing material and gypsum panel into which moisture may collect. Blisters also present an area of weak wind-uplift resistance.

In this embodiment, it is preferred that at least about 75 wt % of the fibers used to prepare the non-woven mats have a length between about one-quarter (¼) to about three-quarter (¾) inch, possibly between about one-quarter (¼) to about one-half (½) inch and even more preferably at least about 90 wt % of the fibers used to prepare the mat have a length between about one-quarter (¼) to about three-quarter (¾) inch, or between about one-quarter (¼) to about one-half (½) inch. For example, it has been observed that a mat prepared using 75% by weight ¼ inch H fibers (about 10-11.5 microns in diameter) and 25% by weight ¾ inch H fibers has shown unexpected benefits in reducing the incidence of frothing in BUR applications when using liquid adhesives.

While not wishing to be bound by the following explanation, the inventors surmise that a pre-coated mat which contains glass fibers having a diameter of no greater than about 11.5 microns, (e.g., which consists essentially of H fibers) and where most, if not all of the fibers used to make the mat have a length somewhere between about one-quarter (¼) to about three-quarter (¾) inch, provide a surface for receiving the liquid adhesive that inhibits solvent penetration, and better insulates and blocks vapor release from the gypsum core.

Typically, but not exclusively, the glass fiber mats used as the base substrate of the pre-coated mat are wet-formed into a continuous non-woven web of any workable width on a Fourdrinier-type machine. Preferably, an upwardly inclining wire having several linear feet of very dilute stock lay-down, followed by several linear feet of high vacuum water removal, is used. This is followed by a “curtain coater,” which applies the glass fiber binder and an oven that removes excess water and cures the adhesive to form a coherent mat structure.

Non-woven mat 16 (see FIGS. 1 and 2), which serves as the upper surface of the gypsum panel when installed as part of a roof deck, preferably has a basis weight (in the absence of any coating) of about 2.0 lbs. per 100 square feet of mat surface area, in particular between 2.0 and 2.5 lbs per 100 square feet. Non-woven mat 14 preferably has a basis weight (in the absence of any coating) of about 1.6 lbs. per 100 square feet of mat surface area.

The coating composition, which is applied to one, free surface of the above-described mats comprises an aqueous mixture of predominately a mineral pigment or filler and an organic binder of a polymer latex adhesive, such as hydrophobic, UV resistant polymer latex adhesive. The coating formulations used on mats 14 and 16 can be the same or different. On a dry weight basis of the two essential components (100%), the organic binder comprises at least about 1% and no more than about 17% by weight, with the balance being the inorganic, mineral pigment or filler. Thus, the weight ratio of the mineral pigment or filler to the polymer latex adhesive (organic) binder can be in excess of 15:1 and in some cases can be in excess of 20:1, but usually is at least about 5:1.

Suitable coating compositions for making the pre-coated non-woven mats contain, on a dry weight basis of the noted components (100%), about 83 to 99 percent mineral pigment or filler, more usually about 88 to 97 percent mineral pigment or filler and about 1 to 17 percent polymer latex adhesive (organic binder), more usually about 3 to 12 percent.

In addition to the two essential components, the aqueous coating composition will also include water and other optional ingredients such as colorants (e.g., dyes or pigments), thickeners or rheological control agents, defoamers, dispersants and preservatives. The amounts of such additional ingredients are proportioned to provide the desired rheological properties (e.g., viscosity) to the aqueous formulation, which is appropriate for the chosen form of application of the composition for retention of the composition on the surface and within the adjacent interstices of the non-woven fibrous mat. Water is usually added to adjust the solids content of the coating formulation to between about 50% and 70% by weight, e.g., about 62% solids. When used, the aggregate amount the other optional ingredients in the coating composition is typically in the range of 0.1 to 5% and generally is not more than about 2% of the dry weight of the coating.

Any suitable method for applying an aqueous coating composition to the non-woven fibrous mat substrate can be used for making the pre-coated mats, such as roller coating, curtain coating, knife coating, spray coating and the like, including combinations thereof. Following application of the aqueous coating composition to the mat, the composition is dried (cured), usually by heat to form the pre-coated mat. Pre-coated mats made in accordance with these teachings are substantially liquid impermeable, but do allow water vapor to pass through during manufacturing of the board.

As noted above, a mineral pigment or filler comprises the major component of the coating composition. Examples of mineral pigments generally suitable for making coated mats useful in the present invention include, but are not limited to, ground limestone (calcium carbonate), clay, sand, mica, talc, gypsum (calcium sulfate dihydrate), aluminum trihydrate (ATH), antimony oxide, or a combination of any two or more of these substances.

The mineral pigment is usually provided in a particulate form. To be an effective mineral pigment for making a coated mat for use in this invention, the pigment should have a particle size such that at least about 95% of the pigment particles pass through a 100 mesh wire screen. Preferably, the pigment has most of, if not all of, the fine particles removed. It has been observed that the presence of an excess amount of fine particles in the coating composition negatively impacts the porosity of the pre-coated mat. A preferred mineral pigment is a limestone having an average particle size of about 40 μm. Such materials are collectively and individually referred to in the alternative as mineral pigments or as “fillers” throughout the remainder of this application.

The second essential constituent, includes, but is not limited to: styrene-butadiene-rubber (SBR), styrene-butadiene-styrene (SBS), ethylene-vinyl-chloride (EVCl), poly-vinylidene-chloride (PVdCl) and poly(vinylidene) copolymers, modified poly-vinyl-chloride (PVC), poly-vinyl-alcohol (PVOH), ethylene-vinyl-acetate (EVA), poly-vinyl-acetate (PVA), polymers and copolymers containing units of acrylic acid, methacrylic acid (together referred to as (meth)acrylic acids)), such as styrene-acrylate copolymers, their esters (referred to together as ((meth)acrylates) or acrylonitrile.

The preferred UV resistant, hydrophobic polymer latex binder adhesives generally are made by emulsion polymerization of ethylenically unsaturated monomers.

Such monomers may include (meth)acrylic acid, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, octadecyl(meth)acrylate, stearyl(meth)acrylate, tetrahydrofurfuryl(meth)acrylate, butoxyethyl(meth)acrylate, ethoxydiethylene glycol (meth)acrylate, benzyl(meth)acrylate, cyclohexyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethoxyethyl(meth)acrylate, methoxypolyethylene glycol (meth)acrylate, methoxypolypropylene glycol (meth)acrylate, dicyclopentadiene(meth)acrylate, dicyclopentanyl(meth)acrylate, tricyclodecanyl(meth)acrylate, isobornyl(meth)acrylate, and bornyl(meth)acrylate. Other monomers which can be co-polymerized with the (meth)acrylic monomers, generally in a minor amount, include styrene, diacetone(meth)acrylamide, isobutoxymethyl(meth)acrylamide, N-vinylpyrrolidone, N-vinylcaprolactam, N,N-dimethyl(meth)acrylamide, t-octyl(meth)acrylamide, N,N-diethyl(meth)acrylamide, N,N′-dimethyl-aminopropyl(meth)acrylamide, (meth)acryloylmorphorine; vinyl ethers such as hydroxybutyl vinyl ether, lauryl vinyl ether, cetyl vinyl ether, and 2-ethylhexyl vinyl ether; maleic acid esters; fumaric acid esters; and similar compounds.

When used, a hydrophobic, UV resistant polymer latex binder adhesive is preferably based on a (meth)acrylate polymer latex, wherein the (meth)acrylate polymer is a lower alkyl ester, such as a methyl, ethyl or butyl ester, of acrylic and/or methacrylic acids, and copolymers of such esters with minor amounts of other ethylenically unsaturated copolymerizable monomers (such as stryrene) which are known to the art to be suitable in the preparation of UV resistant (meth)acrylic polymer latexes, can also be utilized. Another suitable co-monomer is vinyl acetate, which may be used as a co-monomer with, for instance, butyl acrylate in a ratio of 70/30 or smaller of the vinyl acetate to the butyl acrylate.

Useful hydrophobic, UV resistant polymer latex binder adhesives include Rohm & Haas RHOPLEX™ NW-1845K Styrene Acrylic copolymer latex and NeoCar® Acrylic 820. RHOPLEX™ NW-1845K is an ultra low formaldehyde, styrenated acrylic emulsion that is also free of alkyl phenol ethoxylates (APEs). It has a combination of hydrophobicity, toughness and film strength that makes it suitable for coating non-woven fibrous mats. NeoCar® Acrylic 820 is an ultra-small particle size, hydrophobic latex available from Dow Chemical Company and is apparently made by copolymerizing a highly branched vinyl ester with an acrylate. Other suitable hydrophobic, UV resistant polymer latex binder adhesives include Glascol® C37 and Glascol® C44 available from Ciba Specialties Chemical Corporation; Rhoplex® AC-1034 available from Rohm & Haas and UCAR® 626 available from Dow Chemical Company.

As used throughout this specification and in the claims, the terms hydrophobic, hydrophobicity and the like are intended to embrace UV resistant polymers, which yield a three (3) minute Cobb value of below about 1.5 grams for the pre-coated fibrous mat. UV resistant polymers that exhibit a three (3) minute Cobb value of below about 0.5 grams are particularly preferred for making pre-coated fibrous mats. The three minute Cobb value of a resin is determined by a simple procedure which is similar to TAPPI procedure T441. According to the procedure, a coated test mat is prepared by coating a standard glass mat with an aqueous coating formulation and dried at 230° F. (110° C.) for 20 minutes. The coating formulation is prepared by combining 70 parts by weight limestone having an average particle size of about 40 μm (GFP 102 available from Global Stone Filler Products or equivalent) with 17 parts by weight (dry solids basis) of the latex resin and blending thoroughly for 30 seconds. The aqueous formulation is applied to the mat using a simple knife applicator to obtain a dry basis weight of between about 22 grams of coating per sq. ft. on the glass mat (standard glass mat—Johns Manville mat 7594 or equivalent).

A 5.25 inches by 5.25 inches square sample of the coated mat is obtained, weighed and then secured in a 100 cm² Cobb ring. One hundred milliliters of warm (120° F. (49° C.)) water is poured into the ring as rapidly as possible and retained there for 2 minutes and 50 seconds. Then, the water is poured from the ring as quickly as possible (without contacting any other portion of the sample). At the three minute mark, a Couch roller is used with a sheet of blotting paper (rolled forward and backwards once) to remove excess moisture from the sample. The sample then is weighed and the increase in weight is recorded. The test is repeated once and the average of the two weight increase values is considered the three minute Cobb value for that sample. Again, UV resistant latex resins exhibiting a three minute Cobb value of 1.5 gms or below in this test are preferably used to maximize the weathering characteristics of the gypsum board or panel of the present invention.

As noted above, the latex resin also must satisfy a certain level of porosity when used in combination with a mineral filler in making a pre-coated glass mat. The porosity test can conducted with the same coated mat sample prepared in the manner outlined above. Otherwise, a sample of the mat intended for making the gypsum board can be used directly. The test for porosity is a modification of the procedure of TAPPI T460, Gurley method for measuring the air resistance of paper. In this procedure, a sample of the coated mat (approximately 2 inches by 5 inches) is clamped between the 1 in² orifice plates of a Gurley Densometer, Model 4110. The inner cylinder is released and allowed to descend under only its own weight (i.e. by gravity alone) and the elapsed time (measured in seconds) between the instant the inner cylinder enters the outer cylinder of the apparatus until the 300 ml mark on the inner cylinder reaches (enters) the outer cylinder is recorded. The test then is repeated with the sample facing (oriented) in the opposite direction. The porosity, reported in seconds, comprises the average of the two replicates for each sample. A suitable resin exhibits a porosity of less than about 45 seconds and more than about 10 seconds. At porosities of higher than about 45 seconds, the coated mat-gypsum core interface is at a much higher risk of delamination (i.e., blister formation) as the water vapors seek a path to escape during curing of the board. Preferably, the porosity is more than about 20 seconds, so as to minimize bleed through of gypsum during board manufacture.

The inorganic pigment or filler materials also may inherently contain some naturally occurring inorganic adhesive binders. Examples of such fillers, some listed with the naturally occurring binder, include (but are not limited to) the following: limestone containing quicklime (CaO), clay containing calcium silicate, sand containing calcium silicate, aluminum trihydrate containing aluminum hydroxide, cementitious fly ash and magnesium oxide containing either the sulfate or chloride of magnesium, or both. Depending on its level of hydration, gypsum can be both a mineral pigment and an inorganic adhesive binder, but it is only slightly soluble in water, and the solid form is crystalline making it brittle and weak as a binder. As a result, gypsum is not generally preferred for use.

Fillers, which inherently include an inorganic adhesive binder as a constituent and which cure by hydration, also advantageously act as flame suppressants. As examples, aluminum trihydrate (ATH), calcium sulfate (gypsum), and the oxychloride and oxysulfate of magnesium all carry molecules of water bound into their molecular structure. This water, referred to either as water of crystallization or water of hydration, is released upon sufficient heating, actually suppressing flames.

Low cost inorganic mineral pigments and fillers with the properties of those described in the preceding paragraph, thus, may provide three (3) important contributions to the coating mixture: a filler; a binder; and, a fire suppressor.

In order for the pre-coated mat to be most useful in making the gypsum roofing board of the present invention, it is preferred that the coated mat be rolled into rolls of continuous sheet. As a result, the coated mat cannot be so stiff and brittle that it will break upon bending. To accomplish this objective, any inorganic adhesive binder content of the mat coating, when present in a formulation, should constitute a minimal amount of the total dry weight of the coating. In the current formulations, there is no separate addition of any inorganic adhesive. Rolls of a pre-coated glass fiber mat suitable for making the gypsum roofing board of the present invention have been obtained from Owens-Corning as products VL3561 (front face—16 in FIG. 1) and VL3551 (back face—14 in FIG. 1).

The amount and viscosity of the aqueous coating composition applied to the surface of the fibrous mats should be sufficient to embed the surface of the mat substantially completely in the coating, to the extent that on visual inspection (i.e., under no magnification) very few fibers and preferably substantially no fibers can be seen as protruding through the subsequently dried coating. Additionally, the aqueous coating composition will penetrate at least partially into the interstices of the fibrous mat. For the gypsum roofing board, the amount of coating should be equivalent to about 3 lbs., to about 6 lbs. of coating solids per 100 sq. ft. of mat surface area, and usually is between about 3.5 and 4.5 lbs. of coating solids per 100 sq. ft. of mat.

With respect to the thickness of the coating, it is difficult to measure thickness because of the uneven nature of the fibrous mat substrate on which the coating is applied. In rough terms, the thickness of the coating usually should be at least about 0.2 mm, but a coating as thin as 0.1 mm may sometimes suffice. In general, the thickness normally need not exceed about 0.5 mm.

As noted above, the coating composition can be applied by any suitable means to the fibrous mat, for example, spray, brush, curtain coating, knife, roller coating and combinations thereof, with roller coating often being preferred. The amount of wet (aqueous) composition applied to the non-woven mat can vary over a wide range. It is believed that amounts within the range of about 4 to 12 lbs. of aqueous coating composition per 100 sq. ft. of mat will be satisfactory for most applications.

Once applied to the surface of the fibrous mat, the aqueous coating composition is dried, typically in a drying oven, at a temperature and for a time sufficient to remove the water from the coating composition and coalesce the polymer latex adhesive, preferably a hydrophobic, UV resistant polymer latex adhesive, to form an adherent coating, without degrading the coating or the mat. Suitable temperatures and times will be influenced greatly by the equipment being used and can be obtained by those skilled in the art using routine experimentation.

The gypsum panels of this invention, particularly for roofing applications, can be made utilizing an existing, manufacturing line for gypsum wallboard as illustrated in FIG. 1. In conventional fashion, dry ingredients from which the gypsum core is formed are pre-mixed and then fed to a mixer of the type commonly referred to as a pin mixer 20. Water and other liquid constituents, such as soap, used in making the core are metered into the pin mixer where they are combined with the desired dry ingredients to form an aqueous gypsum slurry. The reinforcing fiber, provided in an amount to yield at least about 0.3 lbs fiber per 100 square feet of board, and preferably between 0.4 and 0.6 lbs fiber per 100 square feet of board, preferably is added to the slurry in the pin mixer 20. Foam (soap) is generally added to the slurry in the pin mixer to control the density of the resulting core.

The gypsum slurry is dispersed through one or more outlets from the mixer onto a moving sheet (non-woven fibrous mat) 16, which is indefinite in length and is fed from a roll thereof onto a forming table 21 and advanced by conveyor 22. The non-woven fibrous mat of sheet 16 has a basis weight, in the absence of the coating, of about 2 pounds per 100 square feet. The non-woven fibrous mat of sheet 16 also has a coating 15 on what constitutes the bottom surface of the mat as the mat is fed to the forming table. As described above, the coating comprises a dried aqueous mixture of a mineral pigment and an organic binder comprising a polymer latex adhesive. The basis weight of the coating is between about 3 and 6 pounds per 100 square feet of mat, usually between 3.5 and 4.0 pounds per 100 square feet of mat. Applicants have found that in order to minimize gypsum slurry bleeding through the bottom mat as the mat is squeezed to its desired thickness, particularly for a mat of a nominal thickness of ¼ inch (as described in more detail hereafter), the coating formulation used to coat mat 16 is preferably free of talc.

One stream of gypsum slurry may optionally be discharged through outlet 17 to provide a relatively thin layer of aqueous calcined gypsum slurry 18 on the non-coated surface of sheet 16. When used, the thin layer of gypsum slurry 18 is somewhat denser than the aqueous slurry of gypsum that is used to form the main portion of the core of the gypsum board (main core slurry discharged through outlet 19 to form gypsum slurry layer 23). This higher density region of the core, penetrates into the interstices of the fibrous mat and helps to form a strong bond between the lower density portion of the core and the pre-coated mat facer. Typically, the slurry used to form the thin layer (18) is about 18-20% denser than the density of the slurry (23) used to form the main portion of the core.

As is common practice in the manufacture of conventional paper-faced gypsum board, the two opposite edge portions of the mat or sheet 16 are progressively flexed upwardly from the mean plane thereof and the edges are then turned inwardly at the margins as to provide coverings for the edges of the resulting board.

In making the roofing board of the invention, another pre-coated, non-woven fibrous mat 14, also supplied in roll form, is taken from the roll and fed around a roller 7 onto the top of the gypsum slurry 23 to form facing sheet or back sheet 9, thereby sandwiching the gypsum slurry (core) between the two moving pre-coated glass fiber sheets. The fibrous mats 16 and 14 thus form facings on the set gypsum core that is formed from the gypsum slurry to produce the gypsum roofing board. Mat 14 has a basis weight, in the absence of any coating of about 1.6 pounds per 100 square feet. Mat 14 also has a coating 15 on what constitutes the top surface of the mat as the mat is fed onto the gypsum slurry. As described above, the coating comprises a dried aqueous mixture of a mineral pigment and an organic binder comprising a polymer latex adhesive. The basis weight of the coating is between about 3 and 6 pounds per 100 square feet of mat and usually is between about 3.5 and 4.0 pounds per 100 square feet of mat. As above, a strong bond also is formed between this mat and the gypsum core as previously described.

A conventional shaping roller, or in this case shaping plate 25 and edge guiding devices (not shown) are used to compress the sandwich assembly to the desired thickness, such as a ¼ inch thickness, and maintain the edges of the composite until the gypsum has set sufficiently to retain its shape. Thus, after the (top) fibrous mat 14 is applied, the “sandwich” of fibrous mats and gypsum slurry can be pressed to the desired thickness by the shaping plate 25. Alternatively, the fibrous mats and slurry can be pressed to the desired thickness with rollers or in another manner. The continuous sandwich of slurry and applied facing materials then is carried by conveyor(s) 22. Slurry 23 sets as it is carried along.

As shown in FIG. 2, the resulting structural panel of the present invention 10 comprises a set gypsum core 12 faced with two, preferably pre-coated glass fiber mats, 14 and 16. The surface of at least one and preferably both of the mats is coated with a dried (heat cured) coating, indicated by the numeral 15, of an aqueous coating composition containing a combination (e.g., a mixture) of a mineral pigment; a polymer latex adhesive and, optionally an inorganic adhesive binder. The core 12 of the gypsum panel board includes at least 0.3 lbs., and preferably between 0.4 and 0.6 lbs of reinforcing fibers per 100 square feet of roofing board and also preferably includes a water-resistant additive.

The weight of the board (¼ inch thickness) usually should not exceed about 145 lbs. per 100 sq. ft. Typically, the board (¼ inch thickness) will weigh at least about 130 lbs. per 100 sq. ft. Obviously thicker boards will have a proportionally higher weight per 100 sq. ft.

The ability of the pre-coated fibrous mat used in the present invention to pass water vapor there through is an important feature of the present invention and is such that the drying characteristics of the board are not substantially altered relative to a board faced with previous glass mat facing. This means that industrial drying conditions typically used in continuous gypsum board manufacture also can be used in the manufacture of pre-coated mat-faced board of the present invention. Exemplary drying conditions include dryer (oven) temperatures of about 200° to about 700° F., with drying times of about 30 to about 60 minutes, at line speeds of about 70 to about 400 linear feet per minute.

An added benefit of having coated mats on both surfaces of the gypsum roofing panel is that coatings reduce, if not eliminate, fiber disengagement from the non-woven fibrous mats, which in turn reduces, if not totally eliminates, itching caused by handling the mat-faced gypsum roofing boards of the present invention.

Gypsum roofing boards suitable for use in roof deck systems must satisfy certain characteristics for wide commercial acceptability. A gypsum roofing board must exhibit certain fire-resistant qualities so that any system utilizing the board meets the fire regulations of the relevant municipal code. Surprisingly, a ¼ inch thick gypsum roofing board of the present invention is able to satisfy the Class A fire tests for roof coverings (ASTM E-108), especially each of the Intermittent flame exposure test, the Spread of flame test, and the Burning Brand test.

The gypsum roofing board must also possess adequate strength and water-resistant qualities so that the board sustains its structural integrity when exposed to the elements during both installation and use, particularly various forms of precipitation and wind uplifting. The gypsum roofing board of the present invention should exhibit a two (2) hour Cobb value of no more than 3 grams, preferably no more than 2.5 grams, more preferably no more than 2 grams and most preferably no more than 1.5 grams and also provides an uplift resistance Class 1 roof approval rating (FM 4470 and/or ANSI/UL 1897) in excess of 90 lbs/square foot (4.31 kPa). The DensDeck Prime® roof board of the prior art often experienced difficulty meeting the desired two (2) hour Cobb value. The ¼inch thick gypsum roofing board of the present invention also exhibits upwards of 30% improved peel resistance and strength enhancements, as measured by ASTM C 473 flexural break strengths, relative to the DensDeck Prime® roof board of the prior art. These property improvements help to stiffen the entire roof system diaphragm imparting better wind uplift, reduced foot traffic damage and improved hail resistance to the a roofing assembly.

In the two (2) hour Cobb test, a sample of gypsum panel, 5.25 inches by 5.25 inches square, is obtained, weighed and then secured in a 100 cm² Cobb ring. One hundred milliliters of warm (70° F. (21° C.)) water is poured into the ring as rapidly as possible and retained there for two hours. Then, the water is poured from the ring as quickly as possible (without contacting any other portion of the sample). A Couch roller is used with a sheet of blotting paper (rolled forward and backwards once) to remove excess moisture from the sample. The sample then is weighed and the increase in weight is recorded. The test should be repeated at least once and the average of the weight increase values is considered the two (2) hour Cobb value for that sample.

Installation of a typical roof deck system incorporating the gypsum roofing board of the present invention generally involves the following: (1) a frame for supporting the roof is constructed; (2) a generally planar support structure is attached to the frame to provide a surface for supporting the other components of the roof deck system; (3) the gypsum roofing boards are placed over the support structure and (4) an exterior finishing material having good weathering properties is placed over the gypsum roofing boards. The frame generally comprises parallel spaced trusses onto which a support structure is attached, often corrugated metal sheets. The gypsum roofing board of the present invention then would be secured to the corrugated sheets and a waterproof roofing membrane, which may be alternating layers of asphalt and roofing felt, which may be the peel and stick polymer membranes, or which may be some other material, is then applied. In some constructions, an insulation layer, such as sheets of expanded polystyrene, may be inserted between the support structure and the gypsum roofing boards to reduce energy demands for heating and air-conditioning.

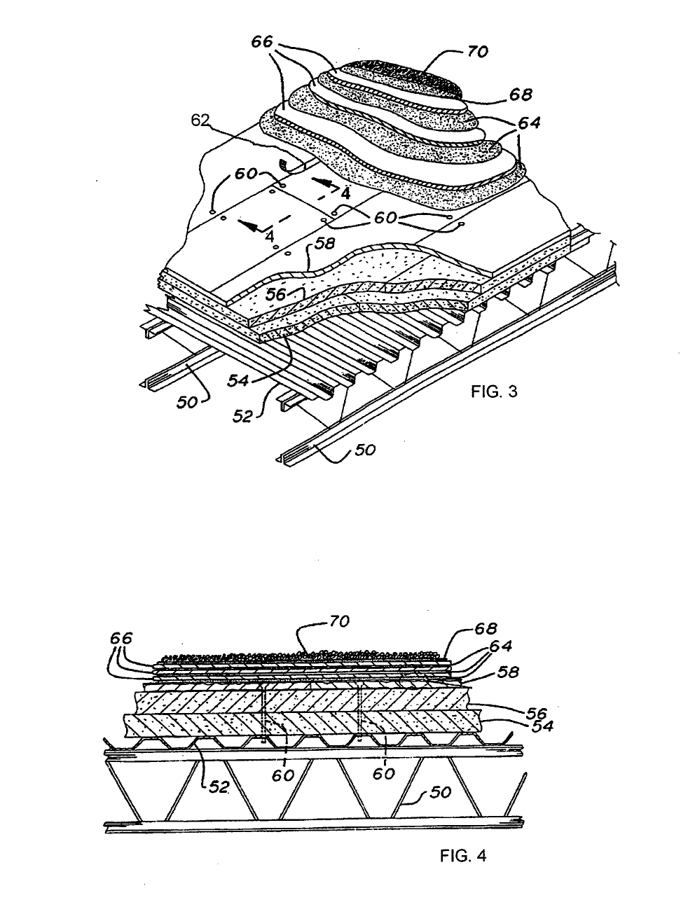

A typical roof deck system incorporating the pre-coated mat-faced structural gypsum panel of the present invention, as described above, is shown in FIGS. 3 and 4. In this roof construction, spaced parallel trusses 50 extend between building support members (not shown) to support a corrugated metal deck 52 which is welded or otherwise fastened to the trusses. Layers 54 and 56 of insulating sheet material, which may, for example, be of expanded polystyrene, are disposed on the corrugated metal deck. A layer 58 of a pre-coated mat-faced gypsum panels of the present invention are secured to the corrugated deck 52 by means of fasteners 60 passing there through and through the underlying insulation layers 54 and 56 into the deck 52. The joints of the panel layer 58 can be sealed by application of tape 62, as shown in FIG. 3 with respect to one of the panel joints. Overlying the gypsum layer 58 is a waterproof roofing membrane comprising alternate layers of asphalt 64 (for example hot-mopped asphalt) and roofing felt 66, three layers of each being shown in the present example. A final coating of asphalt 68 can be covered with a crushed gravel topping layer 70.

As discussed above, it has been observed that a board whose top surface is a pre-coated mat prepared using a mixture of ¼ inch H fibers (about 10-11.5 microns in diameter) and ¾ inch H fibers has shown unexpected benefits in BUR applications when using liquid adhesives. Such panel has shown a significantly lowered incidence of frothing when using liquid adhesives, particularly in BUR constructions, as compared to other gypsum panels made with pre-coated mats having larger fibers diameters.

Installation of a parapet, particularly a dwarf wall along the edge of a roof, also requires the construction of a supporting structure, affixing the gypsum boards to that structure and finishing the assembly with a surface covering.

It will be understood that while the invention has been described in conjunction with specific embodiments thereof, the foregoing description and examples are intended to illustrate, but not limit the scope of the invention. Unless otherwise specifically indicated, all percentages are by weight. Throughout the specification and in the claims the term “about” is intended to encompass + or −5%.

Other aspects, advantages and modifications will be apparent to those skilled in the art to which the invention pertains, and these aspects and modifications are within the scope of the invention, which is limited only by the appended claims.

What is claimed is:

1. A gypsum panel comprising:
(1) a first coated, non-woven fibrous mat, the non-woven fibrous mat containing glass fibers nominally about 10 to 17 microns in diameter, the coating on the first coated non-woven fibrous mat having a basis weight of 3 to 6 pounds of solids per 100 square feet of mat and comprising a dried aqueous mixture of (i) a mineral pigment and (ii) a polymer latex adhesive binder and being substantially free of talc, the polymer latex adhesive binder comprising on a dry weight basis at least about 1% and no more than about 17% by weight of the coating, the first coated non-woven fibrous mat having a coated side and a non-coated side;
(2) a set gypsum core, the core having a density of at least 130 pounds per 100 square feet of the panel and comprising at least about 0.3 lbs. of reinforcing fibers per 100 square feet of the panel, and
(3) a second coated non-woven fibrous mat, the non-woven fibrous mat containing glass fibers nominally about 10 to 17 microns in diameter, the coating on the second coated non-woven fibrous mat having a basis weight of 3 to 6 pounds of solids per 100 square feet of mat and comprising a dried aqueous mixture of (i) a mineral pigment, and (ii) a polymer latex adhesive binder, the polymer latex adhesive binder comprising on a dry weight basis at least about 1% and no more than about 17% by weight of the coating, the second coated non-woven fibrous mat having a coated side and a non-coated side;
wherein the first and second coated non-woven fibrous mats are adhered to the set gypsum core by set gypsum penetrating only partway into the non-coated sides of the fibrous mats; and
wherein the gypsum panel is prepared by depositing a gypsum slurry for forming the set gypsum core onto the non-coated side of the first coated non-woven fibrous mat and forcing the non-coated side of the second coated non-woven fibrous mat into contact with a free surface of the gypsum slurry and allowing the gypsum slurry to harden to form the gypsum core, the first and second coated non-woven mats having a porosity which allows water to evaporate through the coated mats from the gypsum core during preparation of the panel.

2. The gypsum panel of claim 1 which has a thickness of about ¼ inch and a Class A rating in the ASTM E-108 Burning Brand test.

3. The gypsum panel of claim 2 which has a uplift resistance rating under FM 4470 in excess of 90 lbs/square foot.

4. The gypsum panel of claim 3 wherein the first coated non-woven mat has a basis weight in the absence of the coating of about 2.0 pounds per 100 square feet of mat.

5. The gypsum panel of claim 4 wherein the polymer latex adhesive binder on the first coated non-woven fibrous mat is a hydrophobic, UV resistant polymer latex adhesive binder selected from the group consisting of latex polymers and latex copolymers of acrylic acid, acrylic acid esters, methacrylic acid, methacrylic acid esters and acrylonitrile.

6. The gypsum panel of claim 1 wherein the first coated, non-woven fibrous mat contains glass fibers having a diameter of no greater than about 11.5 microns and most of the glass fibers have a length between about one-quarter (¼) to about three-quarter (¾) inch.

7. The gypsum panel of claim 6 wherein at least about 90 wt % of the glass fibers of the first coated, non-woven fibrous mat have a length between about one-quarter (¼) to about three-quarter (¾) inch.

8. The gypsum panel of claim 7 wherein the first coated non-woven mat has a basis weight in the absence of the coating of 2.0 to 2.5 pounds per 100 square feet of mat and the glass fibers of the first coated, non-woven fibrous mat consist essentially of 75% by weight ¼ inch H fibers and 25% by weight ¾ inch H fibers.

9. The gypsum panel of claim 1 wherein the reinforcing fibers are mineral fibers.

10. The gypsum panel of claim 4 wherein the second coated non-woven mat has a basis weight in the absence of the coating of about 1.6 pounds per 100 square feet of mat.

11. The gypsum panel of claim 10 wherein the polymer latex adhesive binder on the second coated non-woven fibrous mat is a hydrophobic, UV resistant polymer latex adhesive binder selected from the group consisting of latex polymers and latex copolymers of acrylic acid, acrylic acid esters, methacrylic acid, methacrylic acid esters and acrylonitrile.

12. The gypsum panel of claim 11 wherein the core has a density of between 135 and 145 pounds per 100 square feet of the panel and comprises between about 0.4 and 0.6 lbs. of reinforcing fibers per 100 square feet of the panel

13. The gypsum panel of claim 12 wherein the coatings on the first and second coated non-woven fibrous mats have a basis weight of 3.5 to 4.0 pounds of solids per 100 square feet of mat.

14. A method of making a gypsum panel comprising
(1) depositing an aqueous slurry of calcined gypsum containing reinforcement fibers onto a first coated non-woven fibrous mat, the non-woven fibrous mat containing glass fibers nominally about 10 to 17 microns in diameter, the coating on the first coated non-woven fibrous mat having a basis weight of 3 to 6 pounds of solids per 100 square feet of mat and comprising a dried aqueous mixture of (i) a mineral pigment and (ii) a polymer latex adhesive binder and being substantially free of talc, the polymer latex adhesive binder comprising on a dry weight basis at least about 1% and no more than about 17% by weight of the coating, the first coated non-woven fibrous mat having a coated side and a non-coated side and wherein the slurry is deposited on the non-coated side;
(2) applying a second coated non-woven fibrous mat onto a free surface of the gypsum slurry, the non-woven fibrous mat containing glass fibers nominally about 10 to 17 microns in diameter, the coating on the second coated non-woven fibrous mat having a basis weight of 3 to 6 pounds of solids per 100 square feet of mat and comprising a dried aqueous mixture of (i) a mineral pigment, and (ii) a polymer latex adhesive binder, the polymer latex adhesive binder comprising on a dry weight basis at least about 1% and no more than about 17% by weight of the coating, the second coated non-woven fibrous mat having a coated side and a non-coated side and wherein the second coated non-woven mat contacts the gypsum slurry on the non-coated side;
(3) forcing the first and second coated non-woven fibrous mats and the gypsum slurry there between to a fixed thickness and
(4) hardening and drying the gypsum slurry with heating to form a set gypsum core having a density of at least 130 pounds per 100 square feet of the panel and comprising at least about 0.3 lbs. of reinforcing fibers per 100 square feet of the panel
wherein the first and second coated non-woven fibrous mats are adhered to the set gypsum core by set gypsum penetrating only partway into the non-coated sides of the fibrous mats.

15. The method of claim 14 wherein the first coated non-woven mat has a basis weight in the absence of the coating of about 2.0 pounds per 100 square feet of mat

16. The method of claim 14 wherein the polymer latex adhesive binder on the first coated non-woven fibrous mat is a hydrophobic, UV resistant polymer latex adhesive binder selected from the group consisting of latex polymers and latex copolymers of acrylic acid, acrylic acid esters, methacrylic acid, methacrylic acid esters and acrylonitrile.

17. The method of claim 14 wherein the second coated non-woven mat has a basis weight in the absence of the coating of about 1.6 pounds per 100 square feet of mat

18. The method of claim 14 wherein the polymer latex adhesive binder on the second coated non-woven fibrous mat is a hydrophobic, UV resistant polymer latex adhesive binder selected from the group consisting of latex polymers and latex copolymers of acrylic acid, acrylic acid esters, methacrylic acid, methacrylic acid esters and acrylonitrile.

19. The method of claim 14 wherein the first coated, non-woven fibrous mat contains glass fibers having a diameter of no greater than about 11.5 microns and most of the glass fibers have a length between about one-quarter (¼) to about three-quarter (¾) inch.

20. The method of claim 19 wherein at least about 90 wt % of the glass fibers of the first coated, non-woven fibrous mat have a length between about one-quarter (¼) to about three-quarter (¾) inch.

21. The method of claim 20 wherein the first coated non-woven mat has a basis weight in the absence of the coating of 2.0 to 2.5 pounds per 100 square feet of mat and the glass fibers of the first coated, non-woven fibrous mat consist essentially of 75% by weight ¼ inch H fibers and 25% by weight ¼ inch H fibers.

22. The method of claim 14 wherein the constant thickness is about ¼ inch.

23. A gypsum panel having a thickness of about ¼ inch made by the method of claim 14.

24. A roof deck assembly comprising: (a) a supporting structure, (b) a gypsum panel of claim 1 overlying the supporting structure and (c) a finishing material overlying the gypsum panel.

25. The roof deck assembly of claim 24 wherein the finishing material is attached to the gypsum panel using a liquid adhesive.
